(19) United States
(12) Patent Application Publication
(10) Pub. No.: US 2016/0082462 A1
(43) Pub. Date: Mar. 24, 2016

(54) Sprinkler Guard

(71) Applicant: William E. McDougald, Colorado Springs, CO (US)

(72) Inventor: William E. McDougald, Colorado Springs, CO (US)

(21) Appl. No.: 14/852,873

(22) Filed: Sep. 14, 2015

Related U.S. Application Data
(60) Provisional application No. 62/052,118, filed on Sep. 18, 2014.

(51) Int. Cl. B05B 15/00; B05B 15/10

(52) U.S. Cl. CPC B05B 15/001; B05B 15/10

(57) ABSTRACT

A sprinkler guard that helps to prevent grass, weeds, and other obstructions from interfering with the operation of the sprinkler. The sprinkler guard includes a baseplate having a central opening thereon. The central opening is sized so as to allow the head of a sprinkler to pass therethrough. In some embodiments, one or more perforated rings are provided around the central opening so as to allow the user to adjust the size of the central opening to fit the sprinkler over which the sprinkler guard will be placed. The baseplate further includes one or more perforated lines along the sides thereof for allowing the user to adjust the size and shape of the baseplate.

### CROSS REFERENCE TO RELATED APPLICATION

This application claims the benefit of U.S. Provisional Application No. 62/052,118 filed on Sep. 18, 2014. The above identified patent application is herein incorporated by reference in its entirety to provide continuity of disclosure.

### BACKGROUND OF THE INVENTION

### Field of the Invention

The present invention relates to sprinkler guards. More specifically, the present invention provides a sprinkler guard comprising a baseplate having a central opening thereon through which the head of a sprinkler can be positioned. In some embodiments, one or more perforated rings are provided around the central opening so that the user can adjust the size of the central opening. Further, one or more perforated lines are provided along the sides of the baseplate so as to adjust the size and shape of the baseplate.

Sprinklers are often installed on lawns and other areas so as to allow the grass and other plant-life in the area to be easily watered. However, as grass grows around the sprinkler, the grass may obstruct the sprinkler head, preventing water from being distributed or causing water to be distributed unevenly. In addition to grass, weeds and other plant-life may grow in the area around the sprinkler and may also serve as obstructions.

Sprinklers can also be difficult to locate when a user is cutting the grass in the area of the sprinkler. As a result, a person mowing the lawn may accidentally contact the sprinkler, damaging the sprinkler and/or the mower. This is particularly true when the grass has grown to a height at or above the height of the sprinkler head. Accordingly, a sprinkler guard is provided that helps to prevent grass and weeds from growing around the sprinkler and to allow a user to more easily locate the sprinklers on the lawn.

Devices have been disclosed in the prior art that relate to sprinkler protectors. These include devices that have been patented and published in patent application publications. These devices generally relate to protectors for sprinkler heads that can be placed on or around a sprinkler so as to prevent damage to the sprinkler, such as U.S. Pat. No. 4,582,256, U.S. Pat. No. 5,102,048, U.S. Pat. No. 3,904,120, U.S. Pat. No. 3,514,040, and U.S. Pat. No. 4,146,181.

These prior art devices have several known drawbacks. Some devices relate to cages to be placed on a sprinkler so as to prevent damage to the sprinkler. Other devices are adapted to be inserted into the ground around the sprinkler, which requires the user to dig around the sprinkler and thus the user must spend additional time installing the sprinkler guard. Thus, the devices in the prior art are not adapted to prevent the growth of grass and weeds around the sprinkler head, and fail to disclose a sprinkler guard comprising a baseplate with a central opening having one or more perforated rings therearound for allowing the user to adjust the size of the central opening.

In light of the devices disclosed in the prior art, it is submitted that the present invention substantially diverges in design elements from the prior art and consequently it is clear that there is a need in the art for an improvement to existing sprinkler guard devices. In this regard the instant invention substantially fulfills these needs.

### SUMMARY OF THE INVENTION

In view of the foregoing disadvantages inherent in the known types of sprinkler guards now present in the prior art, the present invention provides a new sprinkler guard wherein the same can be utilized for providing convenience for the user when preventing grass and plant-life from growing around a sprinkler, interfering with the operation thereof.

It is therefore an object of the present invention to provide a new and improved sprinkler guard comprising a baseplate having a central opening through which the head of a sprinkler is adapted to be positioned.

It is another object of the present invention to provide a sprinkler guard comprising a baseplate adapted to be positioned on the upper surface of the ground around a sprinkler head.

Another object of the present invention is to provide a sprinkler guard comprising one or more perforated rings around the central opening so as to allow the user to adjust the size of the central opening to fit a particular sprinkler.

Yet another object of the present invention is to provide a sprinkler guard comprising a baseplate having one or more perforated lines along the sides thereof for allowing the user to adjust the size of the baseplate.

Another object of the present invention is to provide a sprinkler guard that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a top-down view of the sprinkler guard.

FIG. 2 shows a perspective view of the sprinkler guard in use.

FIG. 3 shows a side cross sectional view of the sprinkler guard in use.

### DETAILED DESCRIPTION OF THE INVENTION

Reference is made herein to the attached drawings. Like reference numerals are used throughout the drawings to depict like or similar elements of the sprinkler guard. For the purposes of presenting a brief and clear description of the present invention, the preferred embodiment will be discussed as used for preventing the growth of plant-life immediately around a sprinkler. The figures are intended for representative purposes only and should not be considered to be limiting in any respect.

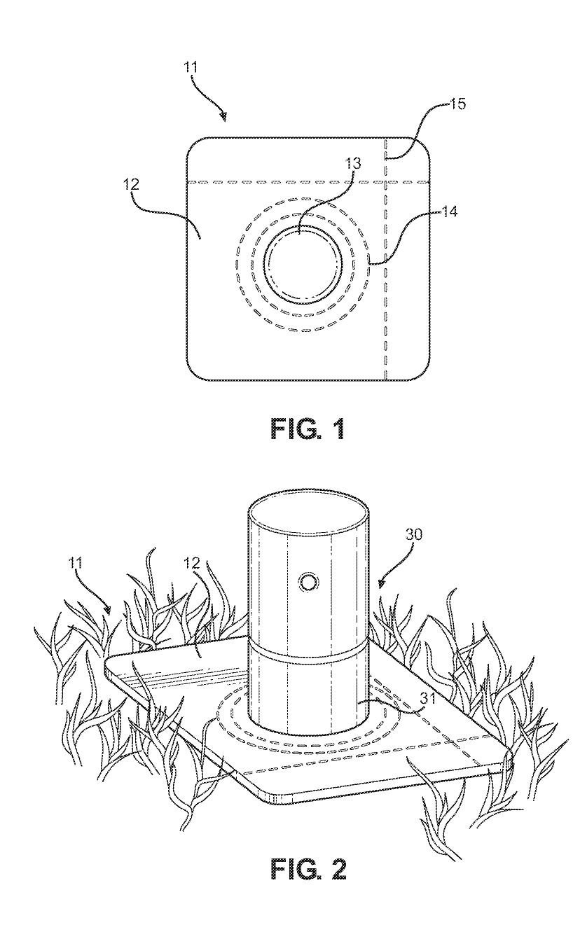

Referring now to FIG. 1, there is shown a top-down view of the sprinkler guard. The sprinkler guard 11 comprises a baseplate 12 having a central opening 13. The baseplate 12 is substantially planar in configuration so that it is adapted to rest on the upper surface of the ground around a sprinkler. In the illustrated embodiment, the baseplate 12 is shown as having a square shape, however, in alternate embodiments, the baseplate 12 may have other shapes such as a circular shape or a rectangular shape, among others. Further, the baseplate 12 preferably comprises rounded corners so that the baseplate 12 lacks any sharp edges or corners. The baseplate 12 is composed of a rigid or semi-rigid material in order to allow the baseplate 12 to remain flat when placed on the ground so that the baseplate 12 is not easily moved out of position.

The central opening 13 is shown as having a substantially circular configuration. The central opening 13 is sized so as to receive the head of a sprinkler therein. In alternate embodiments, the central opening 13 is provided in other shapes so as to accommodate sprinklers having different cross sectional areas. The central opening 13 is centrally located on the baseplate 12 so that the baseplate 12 serves as a buffer between the sprinkler in the central opening 13 and the grass and plant-life around the sprinkler guard 11. The baseplate 12 compacts the grass therebeneath and prevents the grass from growing in the area that it covers so as to allow the sprinkler head to remain unobstructed.

One or more perforated rings 14 are positioned on the baseplate 12 around the central opening 13. The perforated rings 14 are adapted to be easily cut by the user so as to enlarge the central opening 13, so that the sprinkler guard 11 can accommodate sprinklers of various sizes. The perforated rings 14 are preferably concentric about the central opening 13 so that the central opening 13 remains centrally positioned on the baseplate 12. The perforated rings 14 increase in diameter as the distance from the central opening 13 increases. Further, the diameter of each perforated ring 14 preferably increases at a fixed amount. For example, each perforated ring 14 may increase in diameter by one centimeter relative to the adjacent perforated ring 14.

The baseplate 12 further comprises one or more perforated lines 15 along the sides thereof. Each perforated line 15 extends parallel to one of the sides of the baseplate 12 and extends between opposing sides of the baseplate 12. In this way, the user can easily cut the baseplate 12 so as to change the shape of the baseplate 12. It may be necessary to adjust the size of the baseplate 12 wherein a sprinkler is located adjacent to a sidewalk, driveway, or fence. Thus, the user can cut along the perforated line 15 using any suitable tool, such as a saw or knife, among others, in order to adjust the shape of the baseplate 12.

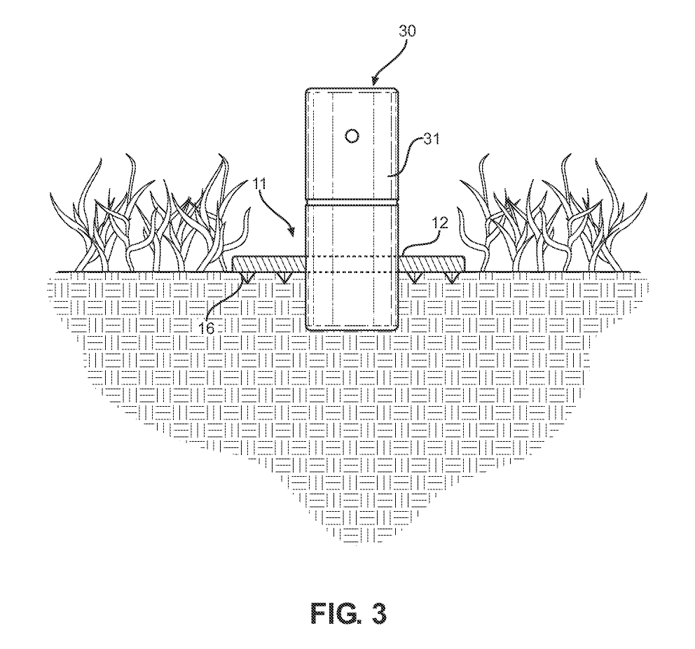

Referring now to FIGS. 2 and 3, there are shown views of the sprinkler guard in use with a sprinkler. The sprinkler guard 11 is adapted to be placed directly on the surface of the ground around a sprinkler 30 so that the sprinkler head 31 passes through the central opening on the baseplate 12. The baseplate 12 covers the ground around the sprinkler 30 so that grass and plant-life cannot grow in the area immediately adjacent to the sprinkler 30. This helps to prevent such plant-life from obstructing the sprinkler and blocking the path of water dispersed by the sprinkler. Further, the central opening is preferably sized similarly to the sprinkler head 31 so that there are no gaps between the baseplate 12 and sprinkler head 31. This helps to prevent grass from growing in the central opening.

In some embodiments, the underside of the baseplate 12 further comprises a plurality of ground-engaging teeth 16 thereon. The teeth 16 are shown as having a triangular configuration, however, in alternate embodiments, the teeth 16 may have various configurations, such as a needle-like configuration. In this way, the baseplate 12 can be positioned on the surface of the ground, wherein the teeth 16 are inserted into the ground and help to prevent the baseplate 12 from moving out of position.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A sprinkler guard, comprising:
a baseplate having a central opening through which a sprinkler is adapted to be positioned;
one or more perforated rings around said central opening, wherein said one or more perforated rings are adapted to be cut so as to change the size of said central opening.

2) The sprinkler guard of claim 1, wherein said baseplate comprises a square configuration.

3) The sprinkler guard of claim 1, wherein said baseplate is composed of a rigid material.

4) The sprinkler guard of claim 1, wherein said central opening is substantially circular in configuration.

5) The sprinkler guard of claim 1, wherein an underside of said baseplate comprises a plurality of ground-engaging teeth.

6) The sprinkler guard of claim 1, wherein said baseplate further comprises one or more perforated lines extending along a side of said baseplate.
